(19) United States
(12) Patent Application Publication
(10) Pub. No.: US 2012/0210951 A1
(43) Pub. Date: Aug. 23, 2012

(54) PROTECTIVE PET GARMENT

(76) Inventor: Joseph T. Leonard, Minneapolis, MN (US)

(21) Appl. No.: 13/397,194

(22) Filed: Feb. 15, 2012

Related U.S. Application Data
(63) Continuation-in-part of application No. 29/410,825, filed on Jan. 12, 2012.
Application No. 29/410,825 is a division of application No. 29/385,539, filed on Feb. 15, 2011, now Pat. No. D652580.
(60) Provisional application No. 61/443,143, filed on Feb. 15, 2011.

(51) Int. Cl. A01K 13/00

(52) U.S. Cl. 119/850

(57) ABSTRACT

A protective pet garment for securing to an animal and including a body portion, configured to cover a portion of an animal's soft underbelly, and a first body strap having a first strap portion attached at a first end to one side of the body portion and a second strap portion attached at a first end to an opposite side of the body portion, second ends of each of the first and second strap portions being removably attached to one another to secure the body strap around the animal. The garment may further include a first cross strap having a first and second end each connected to the body portion, wherein the first cross strap, in conjunction with the body portion, defines an opening configured for receiving a first front leg and a head of the animal to secure the first cross strap over a shoulder of the animal.

### CROSS-REFERENCE TO RELATED APPLICATIONS

This application is a continuation-in-part of U.S. patent application Ser. No. 29/410,825, titled “Protective Animal Garment,” filed Jan. 12, 2012, which is a divisional of U.S. patent application Ser. No. 29/385,539, titled “Protective Animal Garment,” filed Feb. 15, 2011, now issued U.S. Pat. No. D652,580, and also claims priority to U.S. Provisional Pat. Appl. No. 61/443,143, titled “Protective Pet Garment,” filed Feb. 15, 2011, each of which is incorporated by reference in its entirety herein.

### FIELD OF THE INVENTION

The present disclosure relates to protective pet or animal garments. Particularly, the present disclosure relates to garments for a pet or other animal configured for protection of the animal's underbelly, including the soft underbelly and/or abdomen, which may be used, for example but not limited to, for protection during a healing period after a medical procedure, including but not limited to, a spaying procedure.

### BACKGROUND OF THE INVENTION

Pets have increasingly become a very important part of the family structure. As with the rest of the family, pets and can often get wounded, have sores or rashes, have irritated areas, etc. Similarly, pets may sometimes undergo surgical procedures, such as a spaying or neutering procedure. Animals instinctively want to clean their own wounds or scratch and bite their wounds because the wound is irritating or are itchy. It is during these times that the pets may need assistance in the healing process, which may require instruments to keep them from messing with or irritating their wounds.

One attempt at such an instrument is the well-known head “cone” or doughnut collars, which are often a plastic, paperboard, or like material, or an air-filled structure shaped into a cone or doughnut and positioned around the neck and head of the pet so as to preclude the pet from further irritating their wound, irritation, or incision site. While these “cones” and doughnut collars have had some success, pets seem to hate them. Such devices can significantly limit the animal's movement and comfort, such as when eating, drinking, resting, sleeping, playing, etc. Furthermore, such devices fail to keep the animal from rubbing the wound, irritation, or incision site up against other objects.

Other protective instruments and garments have also been designed, such as pet hunting guards, which protect the animal's chest area from ground debris, and full sleeve-like garments, which wrap entirely around the animal's torso. However, hunting guards and the like are limited in the protection they provide, such as only protecting the chest area of the animal during hunting or like activities. Sleeve-like garments can be uncomfortable and do not allow heat to escape, thus causing the animal to overheat. In addition, the above-mentioned garments do not seem to be particularly useful in the protection of wounds, irritations, post-operative incision sites, etc. because they are not configured for protecting the appropriate areas and/or are not configured to promote proper healing or drainage of a wound, irritation, or incision site. Similarly, such garments may have complicated straps or systems or may otherwise be difficult to fit to an animal, which can be frustrating, particularly when the pet does not want the garment on.

Thus, there is a need in the art for a protective garment that can overcome the deficiencies of traditional protective instruments and garments. More particularly, there is a need for garments for a pet or other animal configured for protection of the animal's underbelly, including the soft underbelly and/or abdomen, which may be used, for example but not limited to, for protection during a healing period after a medical procedure, including but not limited to, a spaying procedure.

### BRIEF SUMMARY OF THE INVENTION

The present disclosure, in one embodiment, relates to a protective pet garment for securing to an animal. The garment may include a body portion, configured to cover at least a portion of an animal's soft underbelly, and a first body strap having a first strap portion attached at a first end to a first side of the body portion and a second strap portion attached at a first end to a second side of the body portion, second ends of each of the first and second strap portions being removably attached to one another to secure the body strap around the animal. The garment may further include a first cross strap having a first and second end each connected to the body portion, wherein the first cross strap, in conjunction with the body portion, defines an opening configured for receiving a first front leg and a head of the animal to secure the first cross strap over a first shoulder of the animal. The protective pet garment may also include a second cross strap having a first and second end each connected to the body portion, wherein the second cross strap, in conjunction with the body portion, defines an opening configured for receiving an second front leg and the head of the animal to secure the second cross strap over a second shoulder of the animal.

The present disclosure, in another embodiment, relates to a method for protecting a wound located on the underbelly of an animal. The method may include providing a protective garment having a body portion configured to cover at least a portion of a wound located on an animal's underbelly, a first body strap comprising a first strap portion attached at a first end to a first side of the body portion and a second strap portion attached at a first end to a second side of the body portion, second ends of each of the first and second strap portions being removably attached to one another to secure the body strap around the animal, and a first cross strap having a first and second end each connected to the body portion, wherein the first cross strap, in conjunction with the body portion, defines an opening. The method may also include securing the protective garment to the animal, by aligning the body portion so as to cover the wound of the animal, securing the first body strap around the torso of the animal, and positioning a first front leg and a head of the animal through the opening defined by the first cross strap to secure the first cross strap over a first shoulder of the animal.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a side perspective view of a protective garment according to an embodiment of the present disclosure.

FIG. 2 is a side perspective view of a protective garment according to another embodiment of the present disclosure.

FIG. 3 is a top perspective view of a protective garment according to an embodiment of the present disclosure.

FIG. 4 is a bottom perspective view of a protective garment according to an embodiment of the present disclosure.

FIG. 5 is a side perspective view of a protective garment according to an embodiment of the present disclosure as fitted to an animal.

FIG. 6 is a bottom perspective view of a protective garment according to an embodiment of the present disclosure as fitted to an animal.

### DETAILED DESCRIPTION

The present disclosure relates to novel and advantageous protective pet or animal garments. Particularly, the present disclosure relates to novel and advantageous garments for pets or other animals configured for protection of the animal's underbelly, including the chest, soft underbelly, and/or abdomen.

The protective garment may be used, for example but not limited to, for protection of a wound, sore, or other irritation, protection of a post-operative incision site, general protection of the animal's underbelly, medical treatment or application of a topical medication, or any other suitable use or combination of uses. For example, in one embodiment, the protective garment may be worn by the animal for portions of time during a healing period after a medical or operative procedure, including but not limited to, spaying of the animal or other surgical procedure with an incision site in or near the animal's underbelly. The protective garment may protect against external environmental factors and also may protect against the animal itself, keeping the animal from scratching, biting, licking, rubbing, or otherwise aggravating any wound, sore, incision site, etc. underneath the protective garment. In this regard, the protective garment may be suitable for promoting proper healing of a wound, sore, post-operative incision site, etc. The protective garment may advantageously be used, in some embodiments, as alternatives to the typical protective “cone” worn around the animal's head after medical or surgical procedures, or other similar devices.

The protective garment may be sized and shaped as appropriate for any animal, such as but not limited to, canines, felines, horses. Often, however, the protective garment may be particularly designed and suited for animals of the pet variety, such as pet dogs and cats.

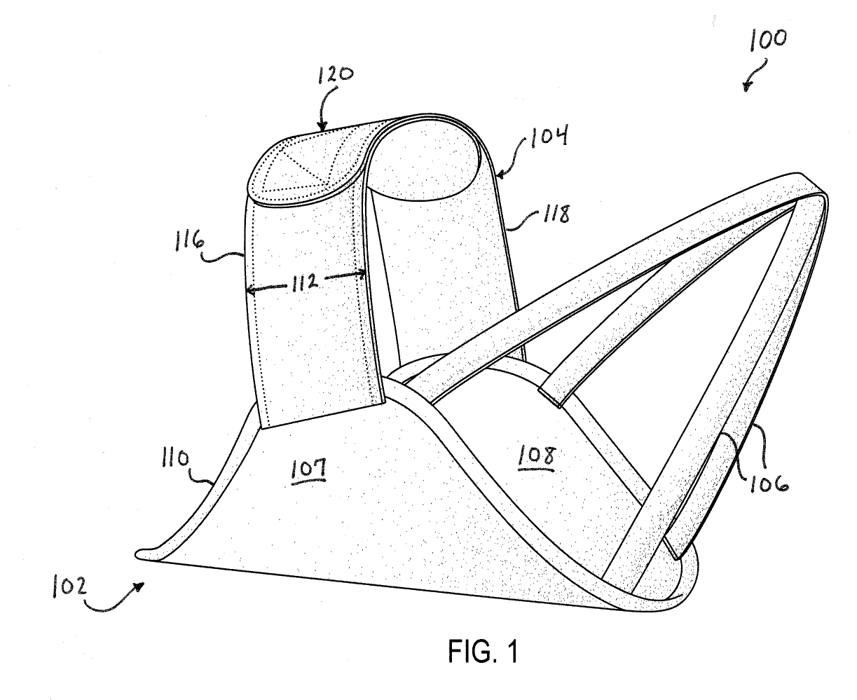

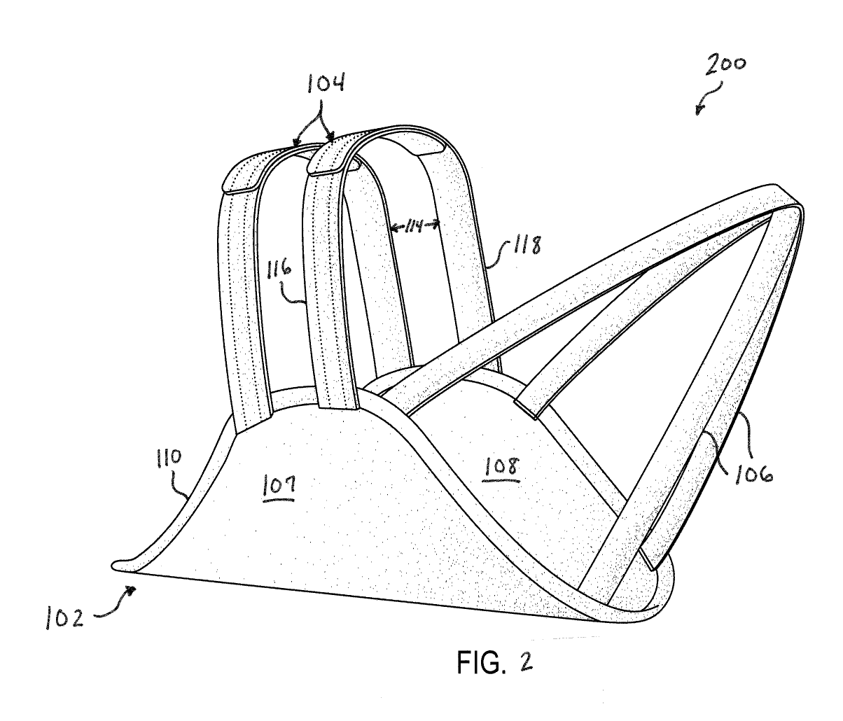

As illustrated in FIGS. 1 and 2, a protective garment 100, 200 of the present disclosure may generally include a body 102 and one or more straps attached or integrated with the body for securing the body to the animal. In one embodiment, protective garment 100 may include one or more body straps 104 and one or more cross straps 106.

The body 102 may generally provide the protective component of the protective garment 100. That is, the body 102 may provide protection for a wound, sore, or other irritation, protection for a post-operative incision site, and/or general protection for the animal's underbelly. In additional or alternative embodiments, the body 102 may provide a means for applying a medical treatment, such as an antibiotic or other medication. It is recognized that there are several other suitable uses or combination of uses for the protective garment 100, and the present disclosure is not limited to solely those uses described in detail.

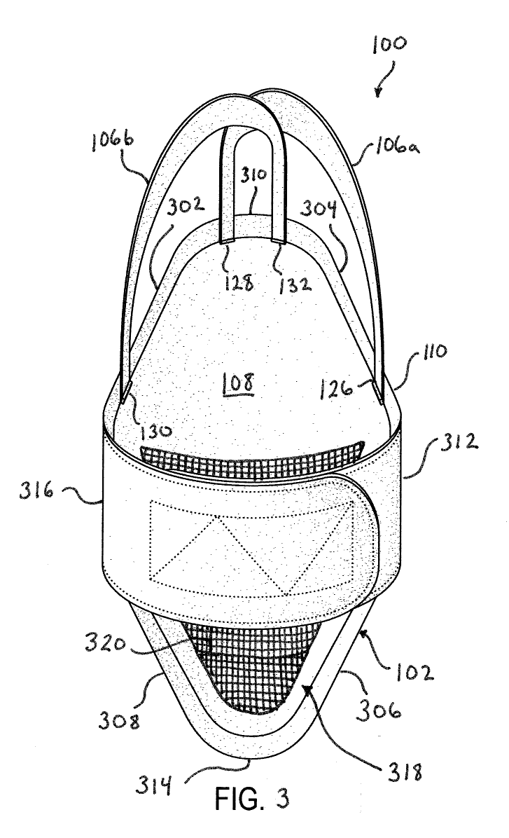

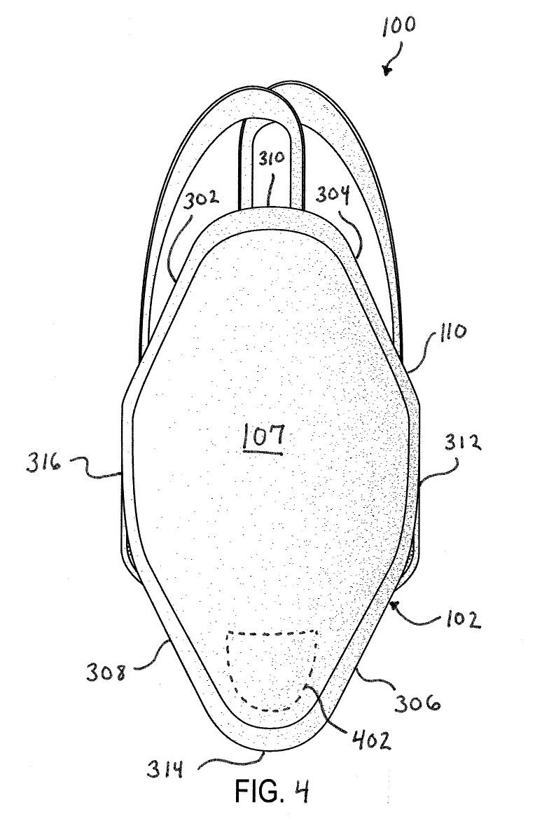

The body 102 may generally extend from approximately an animal's front legs, along the chest and stomach, to approximately the animal's rear legs or near the rear legs. However, it is recognized that the body 102 may be any suitable length to cover a desired wound type, and need not necessarily extend all the way from the front legs to the rear legs. The body 102 may be configured in any suitable regular or irregular shape, such as but not limited to square, rectangle, triangle, polygon, etc., in order to cover a desired portion of, a substantial portion of, or substantially the entirety of, an animal's chest and soft underbelly. For example, in one embodiment, as may be seen best in FIGS. 3 and 4, the body 102 in one embodiment may be generally shaped like a diamond or a baseball park. Specifically, in one embodiment, the body 102 may include four generally straight edges 302, 304, 306, 308 connected therebetween by four corners 310, 312, 314, 316. However, the body 102 may include any suitable number of edges and corners such that the body 102 may cover a desired portion of, a substantial portion of, or substantially the entirety of, an animal's chest and soft underbelly. In one embodiment, one or more of the corners 310, 312, 314, 316 may be generally rounded or semi-circular, which can help prevent discomfort for the animal and/or permit the animal to move its limbs and body easily and freely. The edges 302, 304, 306, 308 need not all be identical in length, and any given edge can have a length that is not equal to one or more of the remaining edges. Similarly, the corners 310, 312, 314, 316 need not all have the same angle, and any given corner may have an acute, right, or obtuse angle which may or may not be equal to one or more of the remaining corner angles.

For example, in one embodiment, as shown best in the FIGS. 3 and 4, the edges 302, 304 configured to be nearest the animal's front legs may be some length shorter than the edges 306, 308 configured to be nearest the animals hind legs. Similarly, the angle of corner 310 configured to be nearest the animal's neck may have a larger angle than corner 314 configured to be nearest the animal's hind end. Thus, as shown in FIGS. 3 and 4, the end of the body configured to be nearest the animal's hind end, or otherwise intended to cover the lower part of the animal's rib cage and/or the animal's soft underbelly may slightly taper. The taper in this area of the body 102 may assure a leaner and/or tighter fit in the animal's soft underbelly area. Such design, although not required, can be advantageous because the diameter of an animal's body in the chest area is often larger than the diameter of the animal's body in the area of the soft underbelly. In additional embodiments, the body 102 of the protective garment 100 may be configured, as desired, to extend significantly toward the animal's hind end to provide more protective coverage for wounds or irritations, for example, that may be located further down the intended animal's underbelly. In most embodiments, but not all embodiments, however, the body 102 can be configured to ensure that it does not preclude or interfere with urination or elimination by the animal.

The sides of the body most near and including corners 312, 316 may be configured to flexibly wrap around at least a portion of the animal's rib cage, such as up to about mid-way around the rib cage. However, the body 102 may wrap any suitable distance around the animal's rib cage, which may depend on the desired fit for the animal.

The body 102 may generally have an exterior side 107, which may generally face away from the animal's body, and an interior or lining side 108, which may generally face inward toward the animal's body and may often be in contact therewith. The body 102 may be a single layer of material. However, in some embodiments, the body 102 has more than one layer, and may include a layer for the exterior side 107 and a layer for the interior side 108. In a further embodiment, the body may also include one or more inner filling layers between the exterior 107 and interior 108 sides. The exterior side 107 or layer of the body 102 may be made from any suitable material or combination of materials, and may often be made from relatively durable materials, such as but not limited to nylon, polyester, or the like, or combinations thereof. Such materials can ensure durability while also being comfortable and flexible. Various other types of materials can be utilized for making the exterior side 107 or layer, such as but not limited to, any suitable water repellant material, which could additionally help to keep the body 102 of the protective garment 100 dry, for example, if the animal comes into contact with water or snow. The interior or lining side 108 or layer of the body 102 may also be made from any suitable material or combination of materials, and may often be made from relatively soft, non-irritating, warm, hygienic, and/or comfortable materials, such as but not limited to cotton, fleece, or the like, or combinations thereof Such materials can ensure comfort and/or hygiene for the animal's chest and/or underbelly. Where the protective garment 100 includes one or more inner filling layers, each inner filling layer may be made from any suitable material or combination of materials for the desired properties, such as soft, warm, cushioning, etc., for the filling, and may include but is not limited to, memory foam, polyester filling, one or more layers of fabric, etc., or combinations thereof The inner filling layer(s) may provide additional support, cushion, warmth, and/or protection.

In embodiments with more than one layer, the exterior side 107 or layer and the interior side 108 or layer may be aligned, with any filling layers or filling positioned between them, and the exterior 107 and interior 108 sides may be affixed together, such as but not limited to, using an adhesive, by sewing, or by any other suitable means of attachment. In one embodiment, as illustrated in the figures, the exterior 107 and interior 108 sides, and optionally any of the filling layers, if any, may be affixed together by sewing a band, such as a cotton or elastic band 110, around or over the edges of the exterior and interior sides. While in some embodiments, the band 110 may be sewn so as to cover each of the edges of the body 102, in other embodiments, the band may be designed or configured so as to cover only a portion or portions of the edges of the body. In even further embodiments, additional stitching may be included across the body 102 at any desirable or suitable location to provide added support for keeping the exterior 107 and interior 108 sides affixed and/or keep any filling in place.

In still further embodiments, the body 102 may include a gauze or bandage area 318 on the interior or lining side 108. The gauze area 318 may include a gauze pad 320, bandage, cloth, or other suitable wound covering for hygienically protecting any wound, irritation, incision site, etc. The gauze area 318 and/or gauze pad (or the like) 320 provided thereat may be configured in any regular or irregular shape, such as but not limited to, square, rectangle, triangle, polygon, etc., and may be configured in any size, which may depend on the size of the intended animal, the size of the body 102 of the protective garment 100, and/or the size and location of the wound, irritation, incision site, etc. intended to be protected by the gauze pad 320. While the gauze pad 320 could be permanent, in some embodiments, the gauze pad (or the like) may be removable and/or replaceable, such that the gauze pad may be cleaned and reattached or disposed and replaced with a new one. The gauze pad 320 or a replacement gauze pad may be removably attached to the gauze area 318, or any other suitable location of the body 102, by any suitable attachment means, such as but not limited to, adhesives, tape, snaps, hook and loop fastener (such as those made by Velcro), etc.

In some embodiments, the gauze area 318 may be used to provide medications, such as but not limited to, topical medications like antibiotics, to the wound, irritation, incision site, etc. to promote proper healing. Such medications may be provided via the gauze pad 320 or other suitable application pad, which may be permanent or removable and replaceable, as described above.

In still further embodiments, a tab or support 402 may be provided within or attached to the body 102 to provide support for the body. The tab 402 may be flexible or rigid, and may be manufactured from any suitable material, such as but not limited to, plastic. In one embodiment, a tab 402 may be positioned in a portion of the body 102 configured to cover a portion of the animal's soft underbelly, which in many cases, may be where the wound, irritation, incision site, etc. meant to be protected is located. In this regard, the tab 402 may provide some level of support or rigidity to that portion of the body 102, and thus may assist in keeping that portion of the body near and/or in contact with the animal's body, rather than hanging loosely. Such a design can be helpful in embodiments having a gauze or bandage area 318, as described above, in order to keep the gauze area in contact with the wound, irritation, incision site, etc. The tab 402 can be affixed internally or externally to the body 102 using any suitable means of attachment, such as but not limited to, adhesives, snaps, sewing, hook and loop fastener (such as those made by Velcro), etc.; in one particular embodiment, the tab may be sewn to the exterior side 107, the interior or lining side 108, or between the exterior and interior sides. If the tab 402 is positioned inside of or between an exterior 107 and interior 108 side, as illustrated in FIG. 4, the tab may thus be protected from any external environment.

The tab 402 may be configured in any regular or irregular shape, such as but not limited to, square, rectangle, triangle, polygon, etc. and may be configured in any size, which may depend on the size of the intended animal and the size of the body 102 of the protective garment 100. Similarly, the tab 402 may have any suitable thickness, which may also vary across the width or length of the tab. In view of the foregoing, however, the configuration of the tab 402 would desirably be selected so as not to significantly interfere with the animal's ability to move easily and freely.

Referring back to FIGS. 1 and 2, the protective garment 100, 200 may include one or more body straps 104 connected or integral with the body 102, and that extend from the body 102 around the animal's torso and help secure the protective garment in position, for example, by preventing the protective garment from significantly sliding off or out of place. The protective garment 100, 200 may include any suitable number of body straps 104, which may depend on the size of the intended animal and/or space along the edges of body 102 of the protective garment. Similarly, the width 112 of the body straps and the spacing 114 therebetween may also vary between embodiments, and may depend on the size of the intended animal or space available along the edges of the body 102.

As indicated above, in some embodiments, the body strap(s) 104 may be integral with the body 102, such that the body straps and body are a unitary structure. However, in other embodiments, the body strap(s) 104 may be operably connected with or attached to the body 102 by any suitable attachment means, such as but not limited to, adhesives, sewing, etc. The body strap(s) 104 may be made of any suitable material or combination of materials, such as elastic, leather, cotton, nylon, etc. In one particular embodiment, the body strap(s) 104 may be made of the same material or materials as the body 102 of the protective garment 100 or some subportion of materials of the body 102. Accordingly, the body strap(s) 104 may include an exterior layer, an interior layer, and any number of filling layers, as discussed above with respect to the body 102.

In one embodiment, a body strap 104 may include two separate detachable strap portions 116, 118 that can each be wrapped around at least one side of the animal's torso and meet somewhere on the back of the animal, or other suitable location around the animal's torso, and be detachably affixed together. Such detachability can make it easier to fit an animal with the protective garment as the garment can be adjusted for the proper support and sizing for the animal. In one embodiment, the separate strap portions 116, 118 of the body strap 104 may affix with hook and loop fasteners (such as those made by Velcro). For example, in one embodiment, a hook and loop fastener 120 may be sewn, glued, or otherwise attached to an end of each detachable strap portion 116, 118 to allow a secure connection between the strap portions. Particularly, a hook and loop fastener may be sewn or otherwise attached to a top-side of one of the separate strap portions 116, and another corresponding hook and loop fastener may be sewn or otherwise attached to the bottom-side of the other separate strap portion 118. Thus, the two strap portions 116, 118 may be connected by overlapping one portion over the other such that the corresponding hook and loop fasteners contact and affix to one another. It is recognized, however, that other means for detachably affixing the separate strap portions, such as but not limited to buckles, magnets, etc., may be suitable and are within the scope of the present disclosure. The body strap(s) 104 or strap portions 116, 118 may further be adjustable in length, such as using elasticity, buckles, or other like devices, in order to modify the length of the strap or strap portions to fit the intended animal.

In further embodiments, the protective garment 100 may include one or more cross straps 106 connected or integral with the body 102, and that extend from the body 102 around the animal's shoulders and also help secure the protective garment in position, for example, by preventing the protective garment from significantly sliding off or out of place. In one particular embodiment, the protective garment 100 may have a first cross strap 106a attached at one end 126 on edge 304 of the body 102 and attached at the other end 128 on edge 302 of the body. While end 126 may be attached at any suitable location along edge 304, in one embodiment, end 126 is attached at, proximate, or relatively nearer to, corner 312. Similarly, while end 128 may be attached at any suitable location along edge 302, in one embodiment, end 128 is attached at, proximate, or relatively nearer to, corner 310. Likewise, the protective garment 100 may have a second cross strap 106b attached at one end 130 on edge 302 of the body 102 and attached at the other end 132 on edge 304 of the body. While end 130 may be attached at any suitable location along edge 302, in one embodiment, end 130 is attached at, proximate, or relatively nearer to, corner 316. Similarly, while end 132 may be attached at any suitable location along edge 304, in one embodiment, end 132 is attached at, proximate, or relatively nearer to, corner 310. In general, as fitted to an animal, one of the straps 106b may attach, at one end, to the body 102 near the inside of the right front leg (e.g., near the chest area) of the animal and may extend over and around the animal's right shoulder with the other end attaching to the body 102 near the back side of the left front leg or on the left side of the body 102. The other strap 106a may attach, at one end, to the body 102 near the inside of the left front leg (e.g., near the chest area) of the animal and may extend over and around the animal's left shoulder with the other end attaching to the body 102 near the back side of the right front leg or on the right side of the body 102. As such, the straps may criss-cross each other approximately at the back of the animal near, or just below, the shoulders.

The cross straps 106 may be attached to the body 102 by any suitable attachment means, such as but not limited to, adhesives, sewing, etc. In other embodiments, as indicated above, the cross straps 106 may be integral with body 102, such that the cross straps and body form a unitary structure.

The cross straps 106 can be made of any suitable material, such as but not limited to, elastic, leather, cotton, nylon, etc. In some embodiments, the cross straps 106 may be made of the same material or combination of materials as the body 102 and/or the body strap(s) 104. However, in one particular embodiment, the cross straps may be made of an elastic or stretchable material, so as to make it simpler and/or quicker to fit the protective garment 102 to the animal. In one embodiment, the cross straps 106 may each be comprised of a single strap, thereby also making it simpler and/or quicker to fit the protective garment to the animal because the animal's legs generally need only be placed through the appropriate areas between the cross straps 106 as described above without requiring adjustment of any buckles. A length adjuster, such as but not limited to, a plastic, metal, composite, etc. ring, may be provided on one or more of the cross straps 106 and may be utilized to manually adjust the length of the cross straps to the appropriate length for the intended animal.

Of course, in other embodiments, one or both of the cross straps 106 may comprise two separate detachably affixable straps that can be wrapped around the shoulder and back of the animal and be detachably affixed together, similar to the body strap(s) 104. In some cases, such detachability may make it easier to fit the animal with the protective garment 100, such as for larger/heavier pets or very active/hyper pets. Additionally, such affixability can permit easy length adjustment of the cross straps 106. In one embodiment, separate straps of a cross strap 106 may detachably affix using hood and loop fasteners (such as those made by Velcro), which permit proper support and sizing adjustment for the animal. However, other means for detachably affixing separate straps, such as but not limited to buckles, magnets, etc., are recognized and within the scope of the present disclosure.

The cross straps 106 may be configured with any suitable length and thickness. In many cases, the length and thickness of the cross straps 106 may depend on the size and shape of the intended animal to which the garment will be fitted.

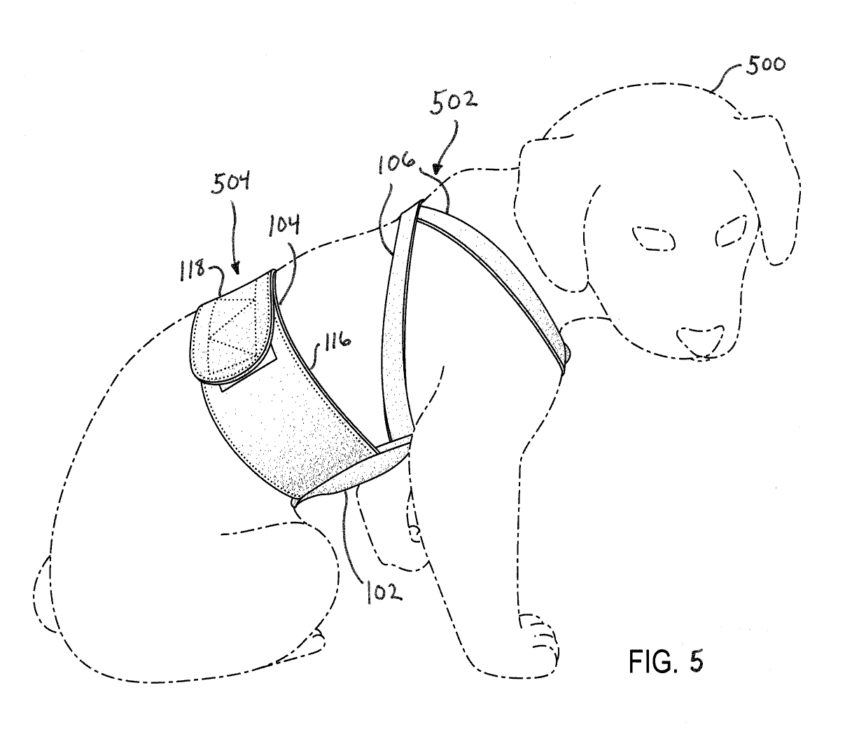

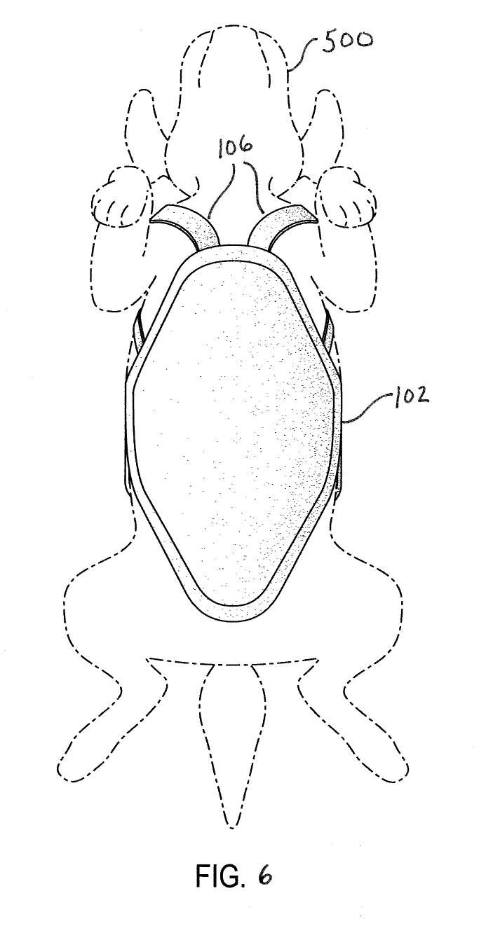

FIGS. 5 and 6 illustrate one embodiment of a protective garment 100 of the present disclosure fitted to a pet animal 500, i.e., a pet dog. Although illustrated with respect to a dog, as mentioned above, the various embodiments of protective garments of the present disclosure are not limited to dogs or even conventional pets.

The protective garment 100 may be relatively easily fitted to a pet animal 500 by positioning the body 102 of the garment on the chest and/or underbelly of the animal with the cross straps 106 toward the front of the animal (toward the head) and the body strap(s) 104 toward the back or rear of the animal, relative the cross straps. If desirable, a permanent or detachable gauze pad 320, as described above, may be positioned in the appropriate gauze area 318 and aligned with any wound, irritation, incision site, etc. of the animal. Similarly, if a tab 402 is provided, it may be aligned to an appropriate position relative the animal's underbelly.

One of the cross straps 106b may be positioned such that it extends from near the inside of the right front leg of the animal, over and around the animal's right shoulder, to near the back side of the left front leg or on the left side of the body 102. The other cross strap 106a may be positioned such that it extends from near the inside of the left front leg of the animal, over and around the animal's left shoulder, to near the back side of the right front leg or on the right side of the body 102. In this regard, the cross straps 106 may criss-cross each other approximately at the back of the animal near, or just below, the shoulders 502.

Separate strap portions 116, 118 of the body strap(s) 104 may each be wrapped around at least one side of the animal's torso and meet somewhere on the back of the animal 504, or other suitable location around the animal's torso, and be detachably affixed together. The body strap(s) 104 may further be adjusted for appropriate fit on the animal.

While described above in the order of positioning the body 102, then positioning the cross straps 106, and then positioning the body strap(s) 104, it is recognized that no such order is required, and the protective garment 100 may be fitted to an animal by positioning the body 102, body strap(s) 104, and cross straps 106 in any suitable order.

While the uses are not limited to such, in one embodiment, the protective garment 100 may be used subsequent a surgical procedure, such as but not limited to, a spaying or neutering procedure or any other procedure resulting in an incision site in the soft underbelly of an animal, to protect the incision site from the external environment. The protective garment 100 can further include a gauze pad or the like, as described above, to properly protect the incision site and/or to apply or cover appropriate topical medications to the site. In this regard, the protective garment 100 can promote proper healing without significantly or substantially impeding the mobility and comfort of the animal.

The various embodiments of protective garments disclosed in the present disclosure may provide several benefits over traditional protective guards, such as head “cones”, doughnut collars, or other traditional chest guards for hunting dogs, which may have at least the disadvantages identified above. For example, the protective garments disclosed herein can be constructed of any suitable materials, including soft, breathable, lightweight, and/or durable materials, which provide comfort and flexibility for the animal. Additionally, fitted with a protective garment as disclosed herein, an animal should have no significant limitations or restrictions while eating, drinking, playing, resting, sleeping, etc. By not completely surrounding the animal's body, the various embodiments of protective garments disclosed herein permit body heat to escape, thus avoiding overheating of the animal, and may also promote better circulation to the wound, irritation, incision site, etc. The protective garments disclosed herein provide protection for various types of wounds and post-operative incision sites, without significantly inhibiting the animal's ability to urinate or eliminate. Cross straps made of elastic can be flexible and durable, permitting the animal to move its head, neck, and shoulders easily and freely, while maintaining the position of the protective garment. Similarly, the cross straps need not attach or interfere with an animal's pet collar, which can significantly reduce or prevent choking or other pulling on the animal's neck area. Additionally, the cross straps do not interfere with the ability of a leash to be attached to the animal's collar. The protective garment, via the body straps and/or cross straps, is easily fitted to an animal and adjustable for proper size. The protective garment can be made from washable materials, and can be readily washed and reused. As discussed above, some embodiments may include an extended or tapered area of the body toward the hind area of the animal, which can provide a larger protective area for some animals. In one particular embodiment, such an extended or tapered area can protect a post-operative incision site resulting from a spaying procedure. Also as discussed above, in some embodiments, corners of the body may be rounded to provide further comfort for the animal. Similarly, the body of the protective garment can be designed so as not to extend up and over the neck of the animal, also providing more comfort. In some embodiments, the body of the protective garment can be configured to extend higher on the sides of the torso of the animal, thereby providing a larger protective area and also limiting the animal's ability to get a paw, claw, or leg underneath the protective garment. Yet another advantage, but certainly not the last, is that elastic cross straps (and/or body straps) can significantly increase the ease by which the protective garment can be fitted or secured to an animal.

In the foregoing description, various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the present disclosure as determined by the appended claims when interpreted in accordance with the breadth they are fairly, legally, and equitably entitled.

We claim:

1. A protective pet garment for securing to an animal, the garment comprising:
a body portion configured to cover at least a portion of an animal's soft underbelly;
a first body strap comprising a first strap portion attached at a first end to a first side of the body portion and a second strap portion attached at a first end to a second side of the body portion, second ends of each of the first and second strap portions being removably attached to one another to secure the body strap around the animal; and
a first cross strap having a first and second end each connected to the body portion, wherein the first cross strap, in conjunction with the body portion, defines an opening configured for receiving a first front leg and a head of the animal to secure the first cross strap over a first shoulder of the animal.

2. The protective pet garment of claim 1, further comprising a second cross strap having a first and second end each connected to the body portion, wherein the second cross strap, in conjunction with the body portion, defines an opening configured for receiving an second front leg and the head of the animal to secure the second cross strap over a second shoulder of the animal.

3. The protective pet garment of claim 2, further comprising a second body strap comprising a first strap portion attached at a first end to the first side of the body portion and a second strap portion attached at a first end to the second side of the body portion, second ends of each of the first and second strap portions being removably attached to one another.

4. The protective pet garment of claim 2, wherein the body portion comprises a first exterior layer and a second interior layer, the interior layer configured for contact with an animal's underbelly.

5. The protective pet garment of claim 4, wherein the interior layer comprises a gauze area having a gauze pad positioned to align with a wound on an animal's underbelly.

6. The protective pet garment of claim 5, wherein the gauze pad is removably attached to the gauze area.

7. The protective pet garment of claim 4, wherein the body portion comprises a tab that is at least semi-rigid and provides support for at least a portion of the body portion.

8. The protective pet garment of claim 7, wherein the tab is fixedly positioned between the exterior and interior layers of the body portion.

9. The protective pet garment of claim 1, wherein the second ends of the first strap portion and second strap portion are removably attached via hook and loop fasteners.

10. The protective pet garment of claim 4, wherein the body portion comprises four substantially linear edges interconnected via four arced corners.

11. The protective pet garment of claim 2, wherein at least one of the first or second cross straps are adjustable in length.

12. A method for protecting a wound located on the underbelly of an animal, the method comprising:
providing a protective garment comprising:
a body portion configured to cover at least a portion of a wound located on an animal's underbelly;
a first body strap comprising a first strap portion attached at a first end to a first side of the body portion and a second strap portion attached at a first end to a second side of the body portion, second ends of each of the first and second strap portions being removably attached to one another to secure the body strap around the animal; and
a first cross strap having a first and second end each connected to the body portion, wherein the first cross strap, in conjunction with the body portion, defines an opening; and
securing the protective garment to the animal, by aligning the body portion so as to cover the wound of the animal, securing the first body strap around the torso of the animal, and positioning a first front leg and a head of the animal through the opening defined by the first cross strap to secure the first cross strap over a first shoulder of the animal.

13. The method of claim 12, wherein the protective garment further comprises a second cross strap having a first and second end each connected to the body portion, wherein the second cross strap, in conjunction with the body portion, defines an opening, and securing the protective garment to the animal further comprises positioning a second front leg and the head of the animal through the opening defined by the second cross strap to secure the second cross strap over a second shoulder of the animal.

14. The method of claim 12, wherein the body portion of the protective garment comprises a first exterior layer and a second interior layer, the interior layer configured for contact with an animal's underbelly when secured to the animal.

15. The method of claim 12, wherein the body portion of the protective garment comprises a gauze area having a gauze pad positioned to align with the wound on the animal's underbelly.

16. The method of claim 15, wherein the gauze pad comprises a topical medication.

17. The method of claim 14, wherein the second ends of the first strap portion and second strap portion are removably attached via hook and loop fasteners.

18. The method of claim 17, wherein securing the first body strap around the torso of the animal comprises adjusting the length of the body strap via the first and second strap portions.

19. The method of claim 12, wherein the wound is a post-operative incision site.

20. The method of claim 19, wherein the animal is a dog or cat and the wound is a post-operative incision site resulting from a spaying or neutering procedure.
